(19) United States
(12) Patent Application Publication
(10) Pub. No.: US 2026/0084088 A1
(43) Pub. Date: Mar. 26, 2026

(54) Method For Controlling A System For Separating Carbon Dioxide From Ambient Air And System

(71) Applicants: Volkswagen Aktiengesellschaft, Wolfsburg (DE); EVERLLENCE SE, Augsburg (DE)

(72) Inventors: Christian HEIMERMANN, Wolfsburg (DE); Marc RUEGGEBERG, Braunschweig (DE); Marcel WIEGEL, Gardelegen / OT Sachau (DE); Peter KAWELKE, Wolfsburg (DE); Martin HOFER, Braunschweig (DE); Klaus BEHNKE, Schriesheim (DE); Stephan WEBER, Herten (DE)

(73) Assignees: Volkswagen Aktiengesellschaft, Wolfsburg (DE); EVERLLENCE SE, Augsburg (DE)

(21) Appl. No.: 19/197,296

(22) Filed: May 2, 2025

(30) Foreign Application Priority Data
May 3, 2024 (DE) 102024112493.8

(51) Int. Cl. B01D 53/04; B01D 53/26; B01D 53/28; B01D 53/30

(52) U.S. Cl. CPC B01D 53/0454; B01D 53/261; B01D 53/28; B01D 53/30; B01D 2253/108; B01D 2257/504; B01D 2257/80; B01D 2258/06; B01D 2259/40088

(57) ABSTRACT

The disclosure relates to a method for controlling a system for separating carbon dioxide from the ambient air. The method comprises conveying a stream of air of the ambient air into a first process space, wherein the stream of air is dried in the first process space, conducting the dried ambient air from the first process space to a second process space, adsorbing carbon dioxide from the dried stream of air with a sorbent material in the second process space, desorbing the carbon dioxide adsorbed in the sorbent material, and storing the desorbed carbon dioxide in a storage unit or transferring the carbon dioxide to a subsequent process. It is provided that the process parameters of the system for drying, adsorption and/or desorption are adjusted on the basis of a degree of loading of the drying agent or the sorbent material.

### CROSS-REFERENCE TO RELATED APPLICATIONS

This application claims priority to German Patent Application No. DE 10 2024 112 493.8, filed on May 3, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for controlling a system for separating carbon dioxide from the ambient air and to a system for carrying out such a method according to the preamble of the independent claims.

Systems and methods for capturing carbon dioxide from the ambient air are known to the inventors. Such a capture can be carried out using what is known as the “direct air capture method,” wherein the carbon dioxide can be captured directly from the ambient air, stored or fed into a further process. Carbon dioxide can be separated from the ambient air using £ different sorbents. Typically, chemisorbents and/or physisorbents are used to separate carbon dioxide. Amine-based chemisorbents have the problem of aging and degradation when the material comes into contact with oxygen at temperatures above approx. 60° C. This can occur during the desorption phase at temperatures of around 100° C. if countermeasures are not implemented, for example an inert atmosphere in the system using water vapor or other gases. These protective measures are laborious and expensive. Physisorbents, such as zeolites, have the problem that the affinity of the sorbent material for water (vapor) is higher than for carbon dioxide, which means that the ambient air must first be dried before being supplied to an adsorption space in which the zeolite material is arranged. Drying the air in this way is also laborious and expensive.

In order to achieve efficient separation of carbon dioxide from the ambient air, systems for the separation of carbon dioxide may for example be operated using renewable energies, in particular hydropower, geothermal energy, wind power, or solar energy. Operation with hydropower would be beneficial, as this can be provided continuously and reliably. However, the potential for generating energy from hydropower is limited to corresponding watercourses and is already almost fully utilized in many regions, such that an expansion of the use of hydropower is limited. Geothermal energy can also be used continuously and is therefore an option at certain locations. Solar energy and wind power can essentially be used regardless of location, but their use is limited by the orbit of the sun and/or the weather conditions at the location.

An issue of such systems, however, is that the adsorption and desorption processes for carbon dioxide and any drying process of the ambient air upstream of the adsorption are influenced by different parameters, such as the ambient temperature, humidity, temperature and carbon dioxide content of the ambient air.

### SUMMARY

A need exists to increase the efficiency of a system for separating carbon dioxide from the ambient air. The need is addressed by the subject matter of the independent claim(s). Embodiments of the invention are described in the dependent claims, the following description, and the drawings.

### BRIEF DESCRIPTION OF THE DRAWINGS

FIG. 1 shows an example embodiment of a system for separating carbon dioxide from the ambient air, which has a drying unit, a sorption unit and a storage unit;

FIG. 2 shows a flow chart of an example method for separating carbon dioxide from the ambient air, taking into account weather parameters;

FIG. 3 shows an example temperature profile over time and the absolute moisture during drying of the drying agent; and

FIG. 4 shows an example profile over time of temperature and pressure in a second process space during desorption of the carbon dioxide.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method comprises:
conveying a stream of ambient air into a first process space, wherein the stream of air is dried in the first process space,
conducting the dried ambient air from the first process space to a second process space,
adsorbing carbon dioxide from the dried stream of air with a sorbent material in the second process space,
desorbing the carbon dioxide adsorbed in the sorbent material, and
storing the desorbed carbon dioxide in a storage unit or transferring the desorbed carbon dioxide to a subsequent process.

In some embodiments, it is provided that the process parameters of the system for drying, adsorption and/or desorption are adjusted on the basis of a degree of loading of the drying agent or the sorbent material. In other words, the process parameters of the system for drying, adsorption and/or desorption are specified depending on the degree of loading of the drying agent or the sorbent material.

The methods according to the teachings herein make it possible to improve the efficiency of a process for separating carbon dioxide from the ambient air by improving the design of the “drying,” “adsorption” and “desorption” sub-processes. In particular, it may be possible to define the termination conditions of the sub-processes in such a way that the loading capacity of the drying agent or, respectively, of the sorbent material is utilized to the maximum.

In some embodiments, it is provided that a water absorption of the drying agent is estimated on the basis of a determined residual moisture content of the air downstream of the drying unit, also referred to herein as ‘dryer’. This enables particularly efficient drying of the ambient air. In particular, energy can be saved by utilizing the maximum absorption capacity of the drying agent, since the number of regeneration cycles for the drying agent can be minimized. It is also possible to prevent ambient air with too high a residual moisture content from being fed into the second process space of the sorption unit (‘sorption space’) , which ensures maximum separation of carbon dioxide in the operation following drying.

In some embodiments, it is provided that regeneration of the drying agent is estimated on the basis of a determined residual moisture content of the air downstream of the drying unit, i.e., after drying of the drying agent. By determining the residual moisture in the ambient air downstream of the drying unit, it is possible to estimate the extent to which the drying agent has already been regenerated or whether further drying is no longer possible or only possible with a disproportionate amount of energy. This means that the drying process can be designed to be as energy-efficient as possible. Since drying is carried out in particular by a stream of purge air, the residual moisture of the purge air downstream of the drying agent, i.e., after flowing through the drying agent, is determined in this case and regeneration is estimated on the basis of the determined residual moisture.

For example, it is possible in some embodiments that a temperature in the drying unit or downstream of the drying unit, in particular a temperature of the drying agent and/or the air in the drying unit or downstream of the drying unit, is also detected. Since the relative humidity is strongly dependent on the temperature, the additional determination of the temperature leads to an improvement in the result of the prediction.

For example, it is possible in some embodiments to deduce the residual moisture of the drying agent from a temperature profile of the temperature in the drying unit or downstream of the first process space. Since the temperature increases as the load decreases, the progress of dehumidification can be deduced from the characteristic temperature profile in or behind the drying material in the first process space.

In some embodiments, it is provided that a saturation of the sorbent material during the adsorption of carbon dioxide is estimated on the basis of a carbon dioxide concentration downstream of the second process space. The load state of the sorbent material is indicated by the carbon dioxide concentration downstream of the second process space. Exceeding a threshold value for the carbon dioxide concentration is suitable as a termination condition for the adsorption process, since it can be assumed that the sorbent material is essentially saturated once the threshold value is exceeded.

In some embodiments, it is provided that a saturation of the sorbent material during the adsorption of carbon dioxide is estimated on the basis of a gradient of the carbon dioxide concentration downstream of the second process space. The gradient of the carbon dioxide concentration downstream of the second process space can also be used to estimate how saturated the sorbent material is.

In some embodiments, it is provided that during a first phase of desorption, a temperature in the sorbent material, a pressure in the second process space and/or a carbon dioxide concentration in the second process space or in a gas stream suctioned from the second process space is determined. Alternatively or additionally and in some embodiments, a temperature in the sorbent material is detected. Since the desorption process is strongly dependent on the parameters of pressure and temperature, these parameters can be used to estimate the degree of saturation of the sorption material in the second process space. In particular, the pressure profile during desorption provides information about the release of gas from the sorbent. The estimation can be further improved by the concentration of carbon dioxide by the carbon dioxide already released during desorption. Alternatively, the gas mass flow or gas volume flow can be measured directly upstream or downstream of the vacuum pump.

Alternatively or additionally and in some embodiments, it is provided that a relative humidity and/or a dew point in the second process space or a product gas stream discharged from the second process space is determined during a second phase of desorption. Especially when using a physisorbent, the absorption capacity for carbon dioxide is strongly dependent on the humidity, and since physisorbents have a higher affinity for water vapor than for carbon dioxide, drying of the sorbent material is beneficial. In order to be able to optimally control such a drying process, it is helpful to know a relative or absolute humidity and/or the dew point of the air leaving the first process space.

In some embodiments, it is provided that the adjustment of the process parameters comprises an adjustment of the process times and/or the desorption temperature in at least one of the process spaces. This allows the required energy to be minimized in at least one sub-process and the process to be trimmed for maximum efficiency.

For example, it is beneficial that the adjustment of the process parameters comprises an adjustment of the process times for drying, adsorption and desorption. This allows the methods to be optimized over the entire course of the process, so that a maximally efficient process is achieved based on the prevailing parameters.

In some embodiments, it is provided that the adjustment of the process parameters comprises an adjustment of the desorption temperature and/or the drying temperature. By adjusting the temperatures, the drying process and/or the desorption process can be adapted depending on the prevailing ambient parameters in order to set the most efficient process control possible in the process spaces of the system.

Furthermore, alternatively or additionally and in some embodiments, it is provided that the adjustment of the process parameters comprises an adjustment of the flow velocity of a stream of air through the system. By adjusting the flow velocity, a stream of air through the process spaces of the system can be set which leads to the best possible drying of the ambient air and/or separation of carbon dioxide from the ambient air.

Some embodiments relate to a system for separating carbon dioxide from the ambient air, comprising:
a conveying element (conveyor) for conveying a stream of ambient air into a first process space, wherein the stream of air is dried in the first process space,
a sorption unit for adsorbing carbon dioxide from the dried stream of air with a sorbent material in a second process space, and for subsequently desorbing the carbon dioxide adsorbed in the sorbent material, and
a storage (storage unit) for storing the desorbed carbon dioxide, and
a processor (control unit) which is configured to execute a method described in the preceding sections.

Such a system makes it possible in some embodiments to improve the efficiency of a process for separating carbon dioxide from the ambient air by improving the design of the “drying,” “adsorption” and “desorption” sub-processes. In particular, with a system according to the teachings herein it is possible to define the termination conditions of the sub-processes in such a way that the loading capacity of the drying agent or, respectively, of the sorbent material is utilized to the maximum. This can increase the efficiency of the system.

In some embodiments, it is provided that a dew point sensor, a humidity sensor, a temperature sensor, a volume flow sensor and/or a mass flow sensor is arranged in the drying unit or downstream of the drying unit and upstream of the sorption unit. Alternatively, the volume flow/mass flow can be inferred by detecting the differential pressure across the sorbent. The drying process can be optimized by detecting process parameters such as the relative or absolute humidity, the temperature, or a volume or mass flow through the first process space.

In some embodiments, it is provided that a humidity sensor and a temperature sensor are arranged downstream of the drying agent.

In some embodiments, it is provided that a temperature sensor is arranged in the drying agent or downstream of the drying agent.

Alternatively or additionally and in some embodiments, it is provided that a temperature sensor, a pressure sensor, a humidity sensor, a sensor for detecting the carbon dioxide concentration, a sensor for detecting the flow velocity, a mass flow sensor and/or a volume flow sensor is arranged in the sorption unit. The adsorption or, respectively, desorption can be optimized by detecting a temperature, a pressure, a humidity, a carbon dioxide concentration and/or a flow velocity through the second process space.

For example, it is provided in some embodiments that one sensor for detecting the carbon dioxide concentration is arranged upstream of the sorbent material and one is arranged downstream of the sorbent material.

For example, it is possible that a sensor for detecting the carbon dioxide concentration, a temperature sensor, a sensor for detecting the humidity in the product gas stream and a volume flow sensor or mass flow sensor are arranged downstream of the sorbent material.

In some embodiments, a changeover valve is arranged between the sorption unit for separating carbon dioxide and the storage unit for separating carbon dioxide. In a first switching position, in particular in a desorption phase, the changeover valve allows the gas stream to be conducted into the storage unit and, in a second switching position, a purge gas stream to be introduced into the sorption unit in order to expel the gas remaining in the sorption unit and the residual moisture from the sorbent material. This purge gas with the residual moisture and/or carbon dioxide discharged from the sorbent material does not enter the storage unit but can be treated separately.

In the embodiments described herein, the described components of the embodiments each represent individual features that are to be considered independent of one another, in the combination as shown or described, and in combinations other than shown or described. In addition, the described embodiments can also be supplemented by features other than those described.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

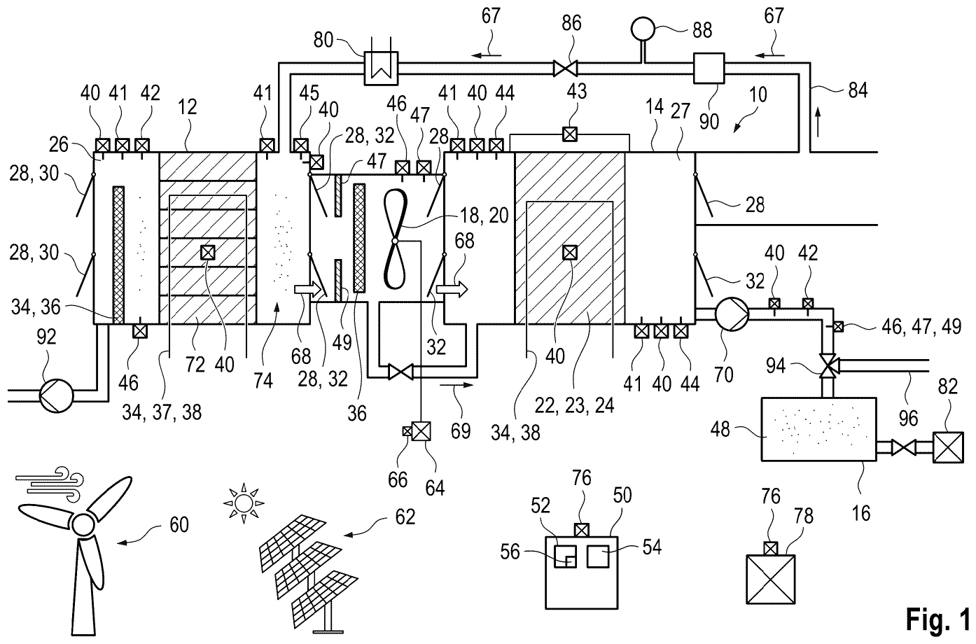

FIG. 1 shows a system 10 for separating carbon dioxide 48 from the ambient air 74. Ambient air is fed to the system 10 and carbon dioxide 48 and water are extracted from this ambient air 74. A stream of exhaust air, which has dry, carbon dioxide-reduced air compared to the incoming air, flows out of the system 10. The system 10 comprises a drying unit 12, in which the humidity contained in the ambient air is at least partially extracted from the stream of air 68. For example, a hydrophilic material such as silica gel can be used as the drying agent 72 for the drying unit 12. In principle, any drying material that is suitable for absorbing moisture from the air can be used. In particular, a sorbent material 22, in particular a physisorbent 23, can also be provided in the drying unit 12 as a drying agent 72. It is beneficial if the sorbent material 22 has not absorbed any carbon dioxide 48 at the end of the drying process. If carbon dioxide 48 is also absorbed at the beginning of or during drying, it must be completely released again during the further absorption of water vapor. This ensures that no carbon dioxide 48 is lost in an uncontrolled manner during the regeneration of the drying stage. For example, a drying agent is used which can be regenerated and fed back into the process by means of appropriate process control after the humidity has been absorbed. The aim is to achieve a degree of drying of the ambient air 74 at which the residual moisture of the ambient air has a dew point of at most −30° C., or for example at most −50° C., or for example at most −60° C.

The system 10 further comprises a sorption unit 14, in which the carbon dioxide 48 from the ambient air 74 is bound. The carbon dioxide 48 in the dried ambient air 74 is stored in a sorbent material 22, in particular in a physisorbent 23, particularly for example in a zeolite material 24.

In addition, the system 10 has a storage unit 16 in which the carbon dioxide 48 separated from the ambient air in the sorption unit 14 is stored in concentrated form. Alternatively, the carbon dioxide 48 can also be fed directly to a further use. The product gas branch also has a changeover valve 94, via which the suctioned product gas stream is conducted either into the storage tank or into a second branch 96. In the first phase of desorption, pure carbon dioxide 48 is obtained and either stored directly or fed into a further process. In a second phase, the remaining moisture is expelled with the aid of purge air. This part of the gas stream should not enter the storage unit 16 due to dilution by the purge air. The system 10 further comprises a conveying element 18, in particular a blower 20, with which a stream of air is passed through the drying unit 12 and then through the sorption unit 14 to the ambient air.

The ambient air 74 is for example dried in a first process space 26, which can be separated from the environment in a substantially gas-tight manner by closure elements 28, in particular by flaps 30, 32. In the exemplary embodiment shown, the first process space 26 has two inlet flaps 30 and two outlet flaps 32. A heating element 34 and/or a cooling element 36 can be arranged in the first process space 26 in order to manipulate the air temperature in the drying unit 12 or, respectively, in the first process space 26. A temperature sensor 40, a pressure sensor 41 and a humidity sensor 42 are each arranged upstream and downstream of the drying agent 72 in the first process space 26 and in the drying unit 12, respectively. One of the two pressure sensors 41 can be replaced by a differential pressure sensor 43. Due to its higher accuracy, this can be used to detect changes in the drying agent 72 in order to detect a change in the throttling behavior when gas flows through the drying agent 72. For example, local changes in the fill level caused by flow effects can be detected. The humidity sensor 42 downstream of the drying agent 72 is for example a dew point sensor 45 for detecting very low residual moistures. The arrangement in each case before and after the drying agent 72 serves to monitor the load state of the drying agent 72 both in the drying phase and in the regeneration phase. The drying system can be monitored using the moisture measurement signals in particular. In the drying phase, a decreasing drying performance can be determined from the increase in the dew point above a threshold value (e.g. −40° C.). During regeneration, the humidity sensor 42 located upstream of the drying agent 72, together with the temperature, provides crucial information on the progress of regeneration.

Furthermore, a sensor 46 for detecting the flow velocity 46, a mass flow sensor 47 and/or a volume flow sensor 49 is arranged at one point in the system 10. A point with a higher velocity is for example selected, for example the connecting channel between the drying unit 12 and the sorption unit 14. A channel that leads the air to the system 10 or away from the system 10 is also suitable for detecting the flow velocity, the mass flow and/or the volume flow.

The adsorption and subsequent desorption of carbon dioxide for example takes place in a second process space 27, which can be separated from the environment in a substantially gas-tight manner by means of closure elements 28, in particular by flaps 30, 32. Furthermore, the second process space 27 has a heating element 34, in particular a heat exchanger 38, in order to be able to raise the temperature accordingly, in particular during the desorption process, and to release the carbon dioxide 48 adsorbed in the sorption material 22. A vacuum pump 70 can be provided at the second process space 27 or, respectively, at the sorption unit 14 in order to manipulate the air pressure in the second process space 27 and, in particular, to lower it during a desorption process. The second process space 27 is fluidically connected to the storage unit 16, in which the carbon dioxide 48 separated from the ambient air can be stored. In the second process space 27 or, respectively, in the adsorption unit 14, a temperature sensor 40, a pressure sensor 41, a humidity sensor 42 and a sensor for detecting the carbon dioxide concentration are each arranged upstream and downstream of the sorbent material 22. One of the pressure sensors 41 can be replaced by a differential pressure sensor 43, as in the drying unit 12.

A conveying element 18, in particular a blower 20, is provided between the drying unit 12 and the sorption unit 14 in order to convey a stream of air 68 of the ambient air first through the drying unit 12 and then through the sorption unit 14. The conveying element 18 has a drive unit 64, the power of which can be adjusted accordingly via a power control 66. Alternatively, the conveying element 18 can also be arranged in a channel for feeding the air to the system 10 or a channel for discharging the air from the system 10.

The system 10 is for example supplied with electricity from renewable energies such as wind power, solar energy or geothermal energy, so as not to generate any additional carbon dioxide emissions during operation. For this purpose, a wind turbine 60 and/or a solar system 62, in particular a photovoltaic system, is provided in order to supply the system 10 with renewable energy.

The system 10 also has a control unit 50 with a storage unit 52 and a computing unit 54, wherein a computer program code 56 is saved in the storage unit 52 and is configured, when executed by the computing unit 54 of the control unit 50, to control the operation of the system 10 for separating carbon dioxide 48 from the ambient air. The control unit 50 can be connected to a data center 78 via a data connection 76, which data center provides the system 10 with data for controlling the system 10 or exchanges data with it.

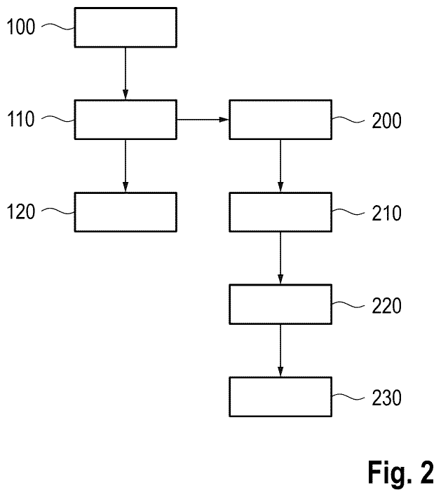

FIG. 2 shows a flow chart for carrying out a method according to the teachings herein for controlling a system 10 for separating carbon dioxide 48 from the ambient air 74. In a first method step <100>, a stream of air 68 of the ambient air 74 is conveyed into a first process space 26 of the system 10, wherein the stream of air 68 is dried in the first process space 26 by the drying agent 72. During the drying process, measured variables are detected which can be used to draw conclusions about the residual moisture of the ambient air 74. One such measured variable is the dew point, which can be determined on the outlet side at the first process space 26 or between the first process space 26 and the sorption unit 14. Alternatively, the relative humidity can also be detected by a humidity sensor 42 to determine the drying performance, provided that the humidity sensor 42 has a corresponding accuracy in the very low humidity range. The absolute moisture can be calculated from this together with the pressure and temperature. Another measured variable in method step <100> is the air mass flow or air volume flow through the system 10. Depending on the current drying capability (dew point) of the drying agent 72, this measured value can be used to vary the air flow rate in subsequent cycles.

In a subsequent method step <110>, the ambient air 74 dried in the first process space 26 is conducted into a second process space 27. In particular, a volume flow or a mass flow of the ambient air 74, a temperature of the ambient air and/or a relative humidity or, respectively, the dew point are determined as measured variables.

In a method step <120>, the drying agent 72 is regenerated again and the moisture bound in the drying agent 72 is expelled again. For monitoring the regeneration of the drying agent 72, the detection of a relative humidity in the first process space 26 downstream of the drying agent 72 in relation to a first stream of purge air 67 is particularly suitable. The absolute moisture can be calculated using the temperature and pressure at the same point, and this can be used as a criterion for the regeneration of the drying agent 72.

In a method step <200>, carbon dioxide 48 is then adsorbed from the dried stream of air 68 with a physisorbent 23 in a second process space 27. During the adsorption of carbon dioxide 48, in particular a carbon dioxide concentration downstream of the second process space 27 is detected and evaluated in relation to the carbon dioxide concentration upstream of the second process space 27. As an alternative to detecting the profile of an absolute carbon dioxide concentration, a gradient of the carbon dioxide concentration can also be detected. Alternatively or additionally, it is possible to determine the degree of loading of the sorbent material 22 using a loading model in which several process-relevant input variables such as the mass or volume flow, the temperature, the process time and/or the flow velocity are taken into account.

In a method step <210>, a first desorption phase of the carbon dioxide absorbed in the sorbent material takes place. To evaluate the desorption process, in particular a carbon dioxide concentration in the second process space 27 or a product gas stream 58 fed from the second process space 27 to a storage unit 16, a mass flow of the product gas stream 58 or a volume flow of the product gas stream 58 and/or a pressure and a temperature in the second process space 27 are detected.

The first desorption phase <210> is followed by a second desorption phase <220>, in which the residual moisture is removed from the sorbent material 22 in the second process space 27. This phase is operated by means of the vacuum pump 70 and a second stream of purge air 69. To evaluate the dehumidification of the sorbent material 22, in particular a physisorbent 23, for example a zeolite material 24, the relative moisture, alternatively the dew point, is measured in the second process space 27, or downstream of the vacuum pump 70. This gas from the second phase is not conducted into the storage unit 52 by means of a changeover valve 94, but is discharged elsewhere. Alternatively or additionally, it is possible to determine the residual moisture of the sorbent material 22 using a loading model in which several method-relevant input variables such as the mass or volume flow, the temperature, the process time and/or the flow velocity are taken into account.

Based on the data determined in the method steps, the process parameters, in particular a duration of a drying, adsorption or desorption, the desorption temperature of the sorbent material 22 and/or the drying temperature of the drying agent 72 as well as the air mass flow through the units 12, 14 of the system 10 are adjusted.

In a method step <230>, the desorbed carbon dioxide 48 from the product gas stream 58 is stored in a storage unit 16 or fed for direct use in subsequent processes.

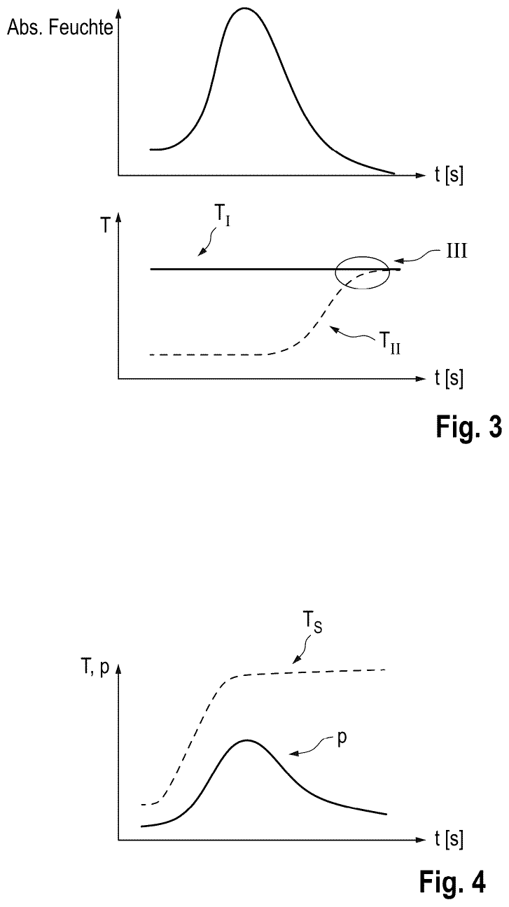

FIG. 3 shows a profile over time of the absolute moisture and a temperature profile during the drying of the drying agent 72. A temperature T_{I} of the first stream of purge air 67 is detected at the input into the drying unit 12 and a second temperature T_{II} is detected at the output of the drying unit 12. As long as the drying is running, the temperature at the output is lower than at the input, since the evaporation of the water from the drying agent 72 requires energy. At a time III the temperatures approach each other, so that it can be assumed that at this time III almost complete drying of the drying agent 72 has been achieved.

FIG. 4 shows a temperature profile in the sorbent material 22 and a pressure profile in the sorption unit 14 during desorption of the carbon dioxide 48 stored in the sorbent material 22. Starting from a strong negative pressure, the pressure initially increases as the temperature increases, which indicates that carbon dioxide 48 is escaping from the sorbent material 22. When the largest gradient of the escaping carbon dioxide 48 is achieved, the pressure drops again to the level that the vacuum pump 70 can achieve. This indicates the moment at which no more carbon dioxide 48 can be desorbed from the sorbent material 22 at this sorbent temperature.

### LIST OF REFERENCE NUMERALS

10 System for separating carbon dioxide
12 Dryer (Drying unit)
14 Sorption unit (Sorption enclosure)
16 Storage (Storage unit)
18 Conveyor (Conveying element)
20 Blower
22 Sorbent material
23 Physisorbent
24 Zeolite
26 First process space
27 Second process space
28 Closure element
30 Inlet flap
32 Outlet flap
34 Heating element (Heater)
36 Cooling element (Cooler)
37 Combined heating and cooling element
38 Heat exchanger
40 Temperature sensor
41 Pressure sensor
42 Humidity sensor
43 Differential pressure sensor
44 Sensor for detecting the carbon dioxide concentration
45 Dew point sensor
46 Sensor for detecting the flow velocity
47 Mass flow sensor
48 Carbon dioxide
49 Volume flow sensor
50 Processor (Control apparatus)
52 Storage unit
54 Computer (Computing unit)
56 Computer program code
58 Product gas stream
60 Wind turbine
62 Solar system
64 Drive unit
66 Power control
67 First stream of purge air
68 Stream of air
69 Second stream of purge air
70 Vacuum pump
72 Drying agent
74 Ambient air/air
76 Data connection
78 Data source
80 Purge air heating
82 Subsequent process
84 Return line
86 Return valve
88 Storage tank
90 Non-return valve
92 Purge air suction pump
94 Changeover valve
96 Discharge line
100 Method step—Conveying a stream of air
110 Method step—Conducting dried ambient air
120 Method step—Regenerating the drying agent
200 Method step—Adsorbing carbon dioxide
210 Method step—First desorption phase
220 Method step—Second desorption phase
230 Method step—Storing the desorbed carbon dioxide

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method of controlling a system for separating carbon dioxide from the ambient air, comprising:
conveying a stream of air of the ambient air into a first process space, wherein the stream of air is dried in the first process space;
conducting the dried ambient air from the first process space to a second process space;
adsorbing carbon dioxide from the dried stream of air with a sorbent material in the second process space;
desorbing the carbon dioxide adsorbed in the sorbent material; and
storing the desorbed carbon dioxide in a storage or transferring the desorbed carbon dioxide to a subsequent process, wherein
process parameters of the system for one or more of drying, adsorption and desorption are adjusted on the basis of a degree of loading of one or more of a drying agent and the sorbent material.

2. The method of claim 1, wherein a water absorption of the drying agent is estimated on the basis of a determined residual moisture of the air downstream of a dryer.

3. The method of claim 1, wherein a regeneration of the drying agent is estimated on the basis of a determined moisture of the air downstream of the dryer.

4. The method of claim 3, wherein a temperature in the drying agent and/or the air in the dryer or downstream of the dryer is additionally detected.

5. The method of claim 4, wherein the residual moisture of the drying agent during regeneration is deduced from a temperature profile of the temperature in the drying agent and/or in the air in the dryer or downstream of the first process space.

6. The method of claim 1, wherein a saturation of the sorbent material during the adsorption of carbon dioxide is estimated based on a carbon dioxide concentration downstream of the second process space.

7. The method of claim 1, wherein a saturation of the sorbent material during the adsorption of carbon dioxide is estimated based on a gradient of the carbon dioxide concentration downstream of the second process space.

8. The method of claim 1, wherein a temperature in the sorbent material, a pressure in the second process space and/or a carbon dioxide concentration in the second process space or in a gas stream suctioned from the second process space is determined during a first phase of the desorption.

9. The method of claim 1, wherein a relative humidity and/or a dew point in the second process space or a product gas stream discharged from the second process space is determined during a second phase of the desorption.

10. The method of claim 1, wherein the adjustment of the process parameters comprises an adjustment of the process times in at least one of the process spaces.

11. The method of claim 1, wherein the adjustment of the process parameters comprises an adjustment of the desorption temperature and/or the drying temperature.

12. The method of claim 1, wherein the adjustment of the process parameters comprises an adjustment of the flow velocity of a stream of air through the system.

13. A system for separating carbon dioxide from the ambient air, comprising:
a conveyor for conveying a stream of air of the ambient air into a first process space, wherein the stream of air is dried in the first process space;
a sorption unit for adsorbing carbon dioxide from the dried stream of air with a sorbent material in a second process space, and for subsequently desorbing the carbon dioxide adsorbed in the sorbent material;
a storage for storing the desorbed carbon dioxide; and
a processor, wherein the processor is configured to execute the method of claim 1.

14. The system of claim 13, wherein a dew point sensor, a humidity sensor, and/or a temperature sensor is arranged in a dryer or downstream of the dryer and upstream of the sorption unit.

15. The system of claim 13, wherein a temperature sensor, a pressure sensor, a humidity sensor, a sensor for detecting the carbon dioxide concentration, a sensor for detecting the flow velocity, a mass flow sensor and/or a volume flow sensor is arranged in the sorption unit.

16. The system of claim 13, wherein a water absorption of the drying agent is estimated on the basis of a determined residual moisture of the air downstream of a dryer.

17. The system of claim 13, wherein a regeneration of the drying agent is estimated on the basis of a determined moisture of the air downstream of the dryer.

18. The system of claim 13, wherein a temperature in the drying agent and/or the air in the dryer or downstream of the dryer is additionally detected.

19. The system of claim 13, wherein the residual moisture of the drying agent during regeneration is deduced from a temperature profile of the temperature in the drying agent and/or in the air in the dryer or downstream of the first process space.

20. The system of claim 13, wherein a saturation of the sorbent material during the adsorption of carbon dioxide is estimated based on a carbon dioxide concentration downstream of the second process space.
